(19) United States
(12) Patent Application Publication
(10) Pub. No.: US 2013/0251147 A1
(43) Pub. Date: Sep. 26, 2013

(54) Lexicon Cryptogram Generation System For Electronic Messaging

(71) Applicant: Rick Peter Bonatto, Folsom, CA (US)

(72) Inventor: Rick Peter Bonatto, Folsom, CA (US)

(21) Appl. No.: 13/429,339

(22) Filed: Mar. 24, 2012

(51) Int. Cl. H04L 9/28

(52) U.S. Cl. 380/255

(57) ABSTRACT

A system and method for automatically creating lexicon word cryptograms from encrypted message information for securely transporting a message via electronic mail, electronic phone messaging, and social media network electronic posting, or blogs via intranet and internet communication systems from any computing stationary or mobile device. The cryptogram message allows for message privacy between the sender and recipient and excluding unintended recipients from detecting and viewing the original message. It lowers the risk of third party invasion of privacy through external systems used in transmission, caching, and storage of messages regardless if the communication system uses encrypted transmission.

### STATEMENT REGARDING FEDERALLY SPONSORED RESEARCH OR DEVELOPMENT

Not Applicable

### BACKGROUND OF INVENTION

1. Field of the Invention

The invention relates to computer implemented cryptogram generation of information for communications system transmission via electronic mail, electronic phone messaging, and social network media and blog posts electronic posting via network communication systems from stationary or mobile devices.

2. Description of the Related Art

Internet systems provide several electronic message transmission vehicles with different levels of message privacy and security.

There are different levels of internet message privacy and security that extend from minimal to highly secure. Message privacy and security are described in terms of the vulnerability of the message to be detected, intercepted, identified, and read.

In general, privacy and security is being enforced through individual user and password account access to the message system. This access allows an individual to create and send a message to one or more recipients. The recipients must also have a separate user and password account on the identical system to retrieve and read the message. Present internet provided systems attempt to ensure privacy and security through said form by ensuring that only the sender and intended recipient have access to the message. Regardless of current security practices, there have been several accounts and cases of intentional invasion of privacy by third parties viewing messages. Third parties intercepting messages used personal information for identity theft and other criminal activities.

The message system creates the message package that includes sender identification and electronic address, recipient identification and electronic address, message subject, message body or the message, and sent time stamp and system routing information. The body of information is a text message and may include attachments. Attachments can be any form of encoded electronic media, such as documents, graphics, pictures, and video. The majority of the internet message systems do not provide any form of message body privacy or security if intercepted. For example, if a sender of a message unintentionally or inadvertently sends it to an untended recipient, the message can be identified and read. Another example, if an unauthorized party or hacker gains access to the message account, this individual can read and send messages on the user's behalf.

Some systems offer private and secure point-to-point transmission between internet system using Secure Socket Layer protocol (SSL). This only mitigates identification and interception of the message during transmission within its point-to-point boundaries. The message itself including the body remains susceptible after transmission.

Most message internet systems intentionally save or unintentionally cache or archive the messages for several seconds and up to several years. Because archive files are periodically transferred to different or alternate storage systems for various system maintenance reasons, it potentially increasing the likelihood of message privacy security breach by unauthorized parties.

### SUMMARY OF INVENTION

Several embodiments are based predominantly on the awareness that there exists a need in providing an adequate method in computing communication systems to secure messages on the most common and widely used electronic email, phone, and social posting messaging network systems and storage. Several embodiments are further based at least in part of providing a method of securing a message through existing cyphering and deciphering techniques in a manner in which it can be transported over any common text based messaging system contained within a stationary or portable computing and communication device. Certain preferred embodiments employ the word scheme technique cryptogram to decrease the likelihood of cryptogram message detection and recoding any meaningful information.

### BRIEF DESCRIPTION OF THE DRAWINGS

FIG. 1 is the high-level process flow chart for embodiments of a user input and the process of ciphering and generating a message cryptogram.

FIG. 2 is the high-level process flow chart for embodiments of a user input and extracting and deciphering the previously generated cryptogram message.

FIG. 3 illustrates the embodiments for encrypting the message and converting the buffered binary output to an encoded series of integer string.

FIG. 4 illustrates the embodiments for converting the encoded integer cryptogram to a lexicon word generated cryptogram final product.

FIG. 5 illustrates the embodiments for parsing lexicon message into tokens and converting the tokens to a series of integers string.

FIG. 6 illustrates the embodiments for converting the series of integers string and decrypting the binary output to the message output buffer.

### DETAILED DESCRIPTION OF THE PREFERRED EMBODIMENT

The detailed description of embodiments to follow is not limited in part or whole to a process on a particular computing system, communication device, software package, or software application, or whether it is stationary or mobile. The embodiments can be included as part or as a plugin utility for use but not limited in electronic mail (Email), text messaging, instant messaging, Short Message Service (SMS), Multimedia Messaging Service (MMS), social network posts (social network web sites), and blogging.

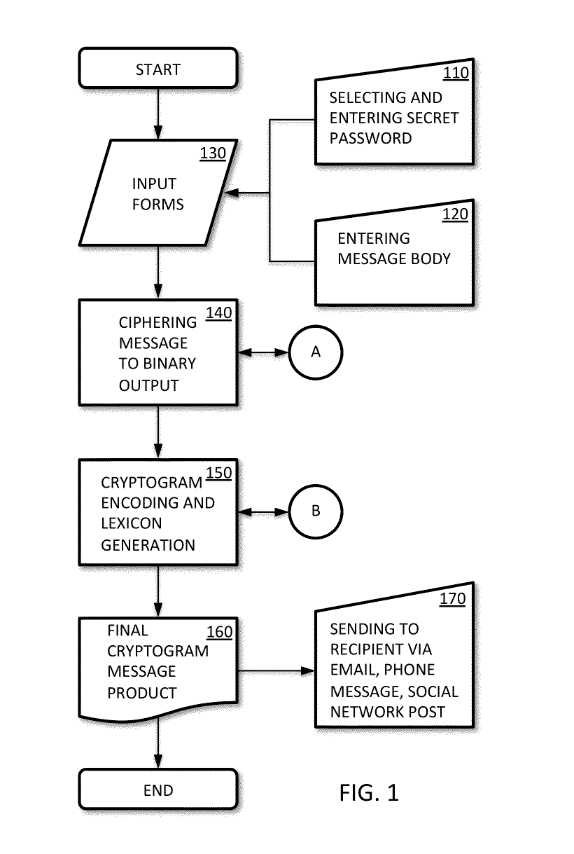

FIG. 1 is a high-level process flow chart of embodiments of converting a message to a cryptogram that will be sent to a recipient over a point-to-point message delivery application and network communication system. The network communication system can be a combination of any local area network, wide area network, via intranet or internet, mobile or stationary computing devices connected over the telephone network, cable network, wireless network, or radio network.

At a minimum, the embodiment requires two inputs in module 130. Input one is a secret password or pass phrase in module 110. Input two is the message body. The message body can be text or other form of encoded media. The password or pass phrase will be used to encrypt the message body in module 140.

The two inputs are passed to an encryption and encoding process as depicted by Module 140.

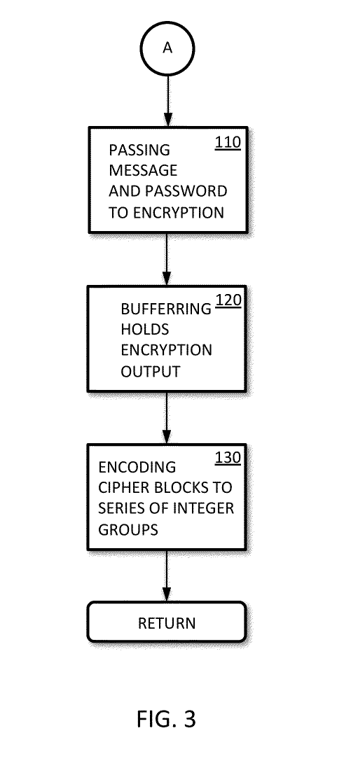

Expanded details of FIG. 1, module 140 are depicted in FIG. 3 at point A. The actual encryption is accomplished by passing the message and a key to module 110. The message can be any length and the key length can be between 1 and 16 characters. The actual ciphering and encryption is accomplished by third party tool in module 110. The encryption and ciphering algorithms of the third party tool are not part of this embodiment; however, the fact that it is part of the overall process is. An example of a third party encryption tool is OpenSSL (Open Secure Socket Layer) and does not exclude other available encryption tools. The encrypted binary ciphered output of the encryption tool is held in a buffer, Module 120, in preparation for a particular encoding described further.

The embodiment for encoding the binary cipher output is depicted in FIG. 3, module 130. The solution to convert or encode the binary cipher block output to a series of UTF8 encoded grouped of text characters and words provides the ability to be transported via text character based communications is the essential form of invention in this embodiment. This solves the problem of transporting ciphered encryption binary bits output that cannot be otherwise transported via plain text messages. The binary block output contains a stream of bytes that are outside the character range and the result would be a loss of bits that would destroy the original message in an attempt to transmit it over conventional text applications. The embodiment is to UTF8 encode the cipher blocks into eight bits per byte. These bytes are represented by integers in the range of 0 to 256 and can be represented in other ranges. For example, a binary block output of 111111110000001 is converted from binary to the set of integer groups 256 and 1 by binary encoding the first 8 bits to a 256 decimal and the second set of 8 bits to 1. This process continues until all the binary blocks are encoded. Furthermore, this embodiment includes the integers are arranged in a series of text numbers separated by spaces; that is, a number delimitated by a space. For example, the sequence “23 1 245 38 188 200 10 41” is eight bytes representing one cipher block. One integer and space for each encoded eight bit per byte. This allows for numbers in a form of text to be conveyed across character based text communications systems.

The following embodiment extends the number encoding into a lexicon generation; that is, words from the English language, any other cultural language, a fictitious language, or random character groups. The module is depicted in FIG. 1, module 150. The reason for this embodiment is to provide against cryptogram detection. There are many unauthorized or malicious message intercepting scanning systems that search for key words to drive a recording device. The lexicon embodiment would render the original message undetectable or a least difficult to detect by not revealing the message as a cryptogram.

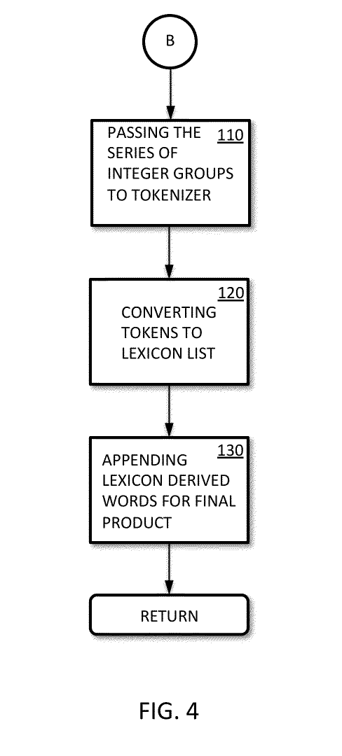

Expanded details of FIG. 1, module 150 are depicted in FIG. 4 at point B. Referring to FIG. 4, module 110, it depicts the embodiment that tokenizes the series of integer groups, each separated by a space, into an array of integers. The array is passed on to module 120, to convert each number into a lexicon word using a dictionary. For example, 23=blue, 197=yellow, and so on. The words can be arbitrary or arranged into logical sets. The remaining embodiment depicted in module 130 is to append the array of lexicon words divided by a space into a string to product the final cryptogram message product. The embodiment allows for a cryptogram to remain in a form of series of integers in lieu of lexicon words as it makes no difference since they are converted to an array of tokens just the same. Language words are preferred process of the embodiment because is reduces security detection of an encoded message stream. An abstract example would encode the original message from “My message.” to “blue orange red yellow raspberry red neon green carrot clear brown tan cyan blue.”

Referring to FIG. 1, module 160, is the final cryptogram message product output. The embodiment depicted in module 170 takes the final cryptogram message product and wraps it as part of a communications message body. The message body is wrapped in header information containing the protocol of delivery, the recipient or recipients destination address, the sender's originating address, and routing information. The embodiment only refers to the fact that is can be transported as a part of a message body or attachment. This embodiment is not including the actual message wrapper and transportation communication devices or means; however the fact that is it part of the process is.

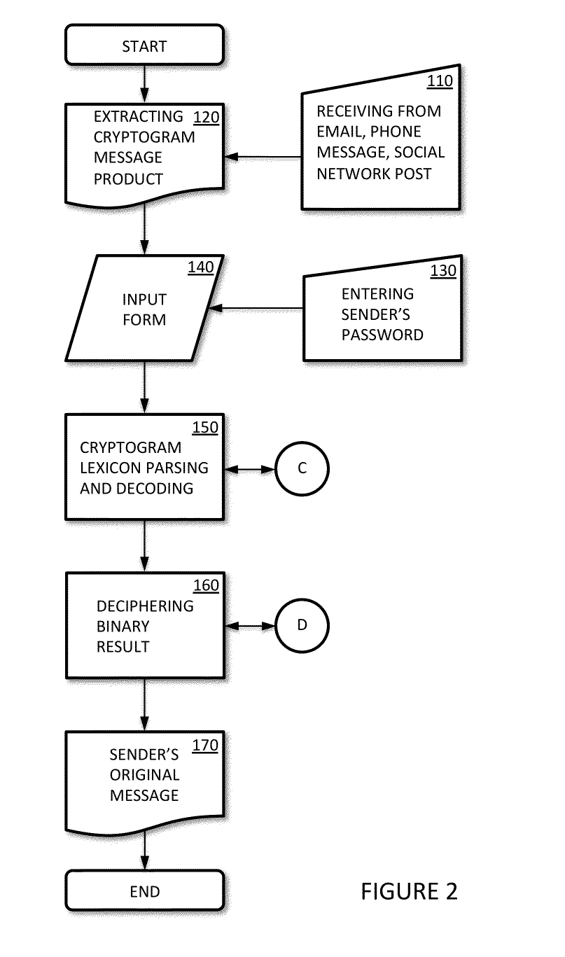

FIG. 2 is a high level process flow chart of embodiments of converting a sender's incoming cryptogram created by the same process detailed in FIG. 1 to its original form to be read by the recipient or recipients. The final cryptogram message product arriving at its destination, the recipient's communications address, over a point-to-point message delivery application and network communication system. The network communication system can be a combination of any local area network, wide area network, via intranet or internet, mobile or stationary computing devices connected over the telephone network, cable network, wireless network, or radio network.

Referring to FIG. 2, module 110 and module 120, depicts the embodiment of the cryptogram message arriving at its destination for processing and decoding and deciphering the cryptogram message to its original form. The following embodiment requires a minimum of two inputs as depicted in module 140. The two inputs are the sender's cryptogram message product as depicted in module 120 and the sender's secret password as depicted in module 140. The recipient must know and use the sender's secret password that created this ciphered message. The next embodiment involves passing the inputs in module 140 to module 150 for parsing the lexicon and decoding the cryptogram message in preparation for deciphering.

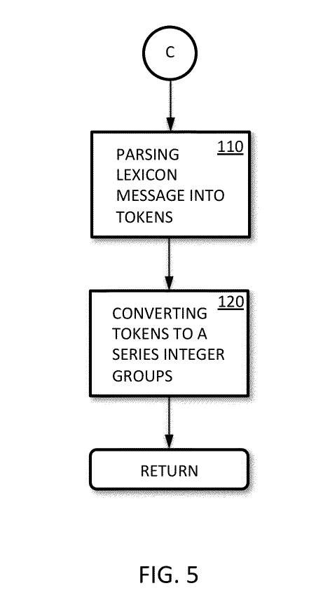

Expanded details of FIG. 2, module 150 are depicted in FIG. 5 at point C. The cryptogram message received is in the form a lexicon series of words or character groups each separated by a space. The embodiment is each lexicon word must be parsed into separate tokens and these tokens will be stored in array in preparation for the next process of decoding the message as depicted in module 110. The embodiment allows for a cryptogram to be already in a form of series of integer groups in lieu of words because it makes no difference as in the end result they are converted to an array of integers. Language words are preferred process of the embodiment because it reduces the likelihood of encrypted message detection by a scanning the message stream.

The following embodiment is the process of translating the array of tokens to the original series of integer groups as depicted in module 120. It takes the lexicon word or character groups and matches it up with the same dictionary list that was used to create it. This embodiment allows for the dictionary to be lexicon word list from the English language, any other cultural language, a fictitious language, or random character groups. Using the same example as previously described in paragraph [0022], it converts to blue=23, yellow=197, and so on. The series of integers are returned and passed on the deciphering tool from module 150 to module 160 in FIG. 2.

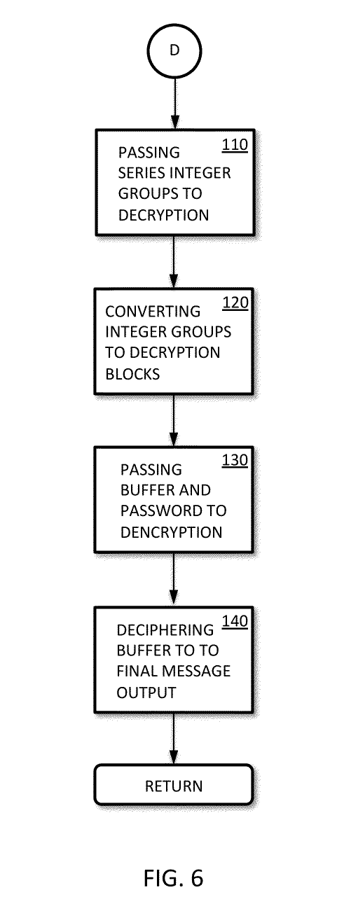

Expanded details of FIG. 2, module 160 are depicted in FIG. 6 at point D. This embodiment encapsulates decoding the series of integer groups from module 110, back to the original encryption blocks in preparation for decryption to module 120. Each integer is decoded to eight bits per byte storing them in a buffer as depicted in module 120. The conversion process takes numbers in the range of 0 to 255 or other range used in the original encoding and converts them to eight bit binary output. For example, the set of integer groups 256 0 are converted to 1111111100000001 binary. The first integer converts to first eight bits and the second to an additional eight bits. This process continues until all the integers are decoded into cipher blocks and stored in a buffer.

Referring to FIG. 6, module 140, this embodiment depicts the process of passing the binary buffer output from module 130 and password entered previously in FIG. 2, module 130, to the third party decryption tool. The decryption and deciphering algorithms of the third party tool are not part of this embodiment; however, the fact that it is used as part of the overall process is. The result of processing by the decryption tool is the sender's original message. The original sender's message is depicted in FIG. 2, module 170, and at this point it is presented and read by the recipient. If the original password entered is incorrect, the deciphering process continues and the resulting message would be an unreadable and unrecoverable. The final result message presentation is a set of random, symbols, number, and non-displayable incoherent characters. If the password entered matches the sender's password, the original message would be revealed.

In an abstract example of the overall process of this software application from FIG. 1 through FIG. 2 in this embodiment taking “My message” and password “s3cr3t” converting it to the cryptogram “blue orange red yellow raspberry red neon green carrot clear brown tan cyan blue” sending it through a communication system device across the network. Furthermore, this software application receiving the cryptogram message “blue orange red yellow raspberry red neon green carrot clear brown tan cyan blue” and entering the password “s3cr3t” to retrieve and view the original message “My message.”

What is claimed is:

1. A computer implemented technique of ciphering and encoding text and graphic messages into word based cryptogram wherein only a sender and recipient can view its original form by using an identical password key, the method comprising:
encrypting and decrypting a message using a ciphering third party utility and a password key in preparing for a particular encoding and decoding technique to create a cryptogram that facilitates transportation through common text based electronic messaging communication systems;
encoding and decoding encrypted binary output to and from a series of character based integer groups and lexicon words representing a cryptogram;
interchanging integers to lexicon words and lexicon words to integers using a pre-defined dictionary;
and, the cryptogram in its text form is transportable through common email, SMS, MMS, social network media, and blog posts.

2. The method of claim 1, wherein the method comprises programmatically generating a cryptogram represented by a set of lexicon words by encoding an encrypted text message and password key.

3. The method of claim 1, wherein the method comprises translating a third party software utility encrypted binary output into groups of encoded integer groups that represent each ciphered block of bytes.

4. The method of claim 1, wherein the method comprises interchanging each integer group key with a value based on a dictionary lexicon word.

5. The method of claim 4, further comprising forming a key to value dictionary lookup from integers to lexicon words and the words may be derived from any real language, fictitious language, or arbitrary groups of characters.

6. The method of claim 1, wherein the method comprises the lexicon words result are appended into a series of delimited text as the cryptogram product to be transmitted.

7. The method of claim 6, further comprising the transmission of cryptogram product as the message segment through common text based electronic messaging communication system.

8. The method of claim 1, wherein the method comprising to decode and decrypt the cryptogram message to its original form by reversing the order that created it.

9. The method of claim 8, further comprising the receipt of a cryptogram product as the message segment through common text based electronic messaging communication system and decoding it to view its original form using only the originator's identical password key.
